(19) United States
(12) Patent Application Publication
(10) Pub. No.: US 2009/0101032 A1
(43) Pub. Date: Apr. 23, 2009

(54) Hand-Held Stamp Having Integrated Components

(76) Inventors: Shawn B. Slane, Waseca, MN (US); Randall L. Bice, Cleveland, MN (US); Lee L. Wencl, Richfield, MN (US)

Correspondence Address: MOORE & HANSEN, PLLP, 225 SOUTH SIXTH ST, MINNEAPOLIS, MN, 55402, US

(21) Appl. No.: 12/256,830

(22) Filed: Oct. 23, 2008

Related U.S. Application Data
(60) Provisional application No. 60/982,086, filed on Oct. 23, 2007.

(51) Int. Cl. B41K 1/42

(52) U.S. Cl. 101/333

(57) ABSTRACT

A self-inking hand-held stamp includes a sub-assembly having an ink cartridge supplied in a pre-inked condition, and a separate sub-assembly for retailers at the point of sale or other field personnel to flash with the desired stamp image. Use of a pre-inked and pre-assembled ink cartridge permits that sub-assembly to be stocked in a field location well in advance of when the actual stamp is flashed and assembled at the point of sale.

### REFERENCE TO RELATED APPLICATION

This application claims the benefit of U.S. Provisional Patent application No. 60/982,086 filed Oct. 23, 2007.

### TECHNICAL FIELD

This application concerns hand-held stamps of the type that employ a porous, inked material bearing an image, and methods of making the same.

### BACKGROUND

Certain types of self-inking hand stamp are manufactured by irradiating or “flashing” a porous foam material with a pattern of radiation that seals portions of the surface of the foam. When the foam material is assembled into the stamp, the flashed portions do not pass ink from a reservoir within the stamp, through the foam material, and onto a workpiece (paper, etc.) as do the remaining (non-flashed) porous portions of the material.

### SUMMARY

A self-inking hand-held stamp includes a sub-assembly having an ink cartridge supplied in a pre-inked condition, and a separate sub-assembly for retailers at the point of sale or other field personnel to flash with the desired stamp image. Use of a pre-inked and pre-assembled ink cartridge permits that sub-assembly to be stocked in a field location well in advance of when the actual stamp is flashed and assembled at the point of sale.

### BRIEF DESCRIPTION OF THE DRAWINGS

The accompanying figures show a particular preferred embodiment as an example, but such illustration is not intended to limit the scope of the claims. In particular, the proportions and/or dimensions that may be shown in, or suggested by, the figures are preferred but not required except as specifically set forth in the claims.

FIG. 1 is a perspective assembled view of a preferred embodiment.

FIG. 2 is a perspective exploded view of the embodiment of FIG. 1.

FIG. 3 is a front cross-sectional view of the embodiment of FIG. 1.

FIG. 4 is a perspective view of a partial assembly of the embodiment of FIG. 1.

FIG. 5 is a front cross-sectional view of the partial assembly of FIG. 4.

FIG. 6 is a bottom view of a component of the partial assembly of FIG. 4.

FIG. 7 is a perspective view of the component of FIG. 6.

FIG. 8 is a perspective view of another component.

FIG. 9 is a perspective view of a sub-assembly comprising the component of FIG. 8 and another component.

FIG. 10 is a cross-sectional view of the two components of FIG. 9, revealing a third component not visible in FIG. 9.

FIG. 11 is cross-sectional view of two of the three components of FIG. 10.

FIGS. 12 and 13 are front and rear perspective views of an alternative embodiment of the base component.

### DETAILED DESCRIPTION

In general terms, several types of self-inking hand-held stamps (or stampers) are known commercially. Therefore, conventional details of construction and operation of components not specific to the claims are not recited below, but are within the skill in the art. In particular, various components may fit together as depicted in the figures even if such fitting is not specifically described below.

### Overview

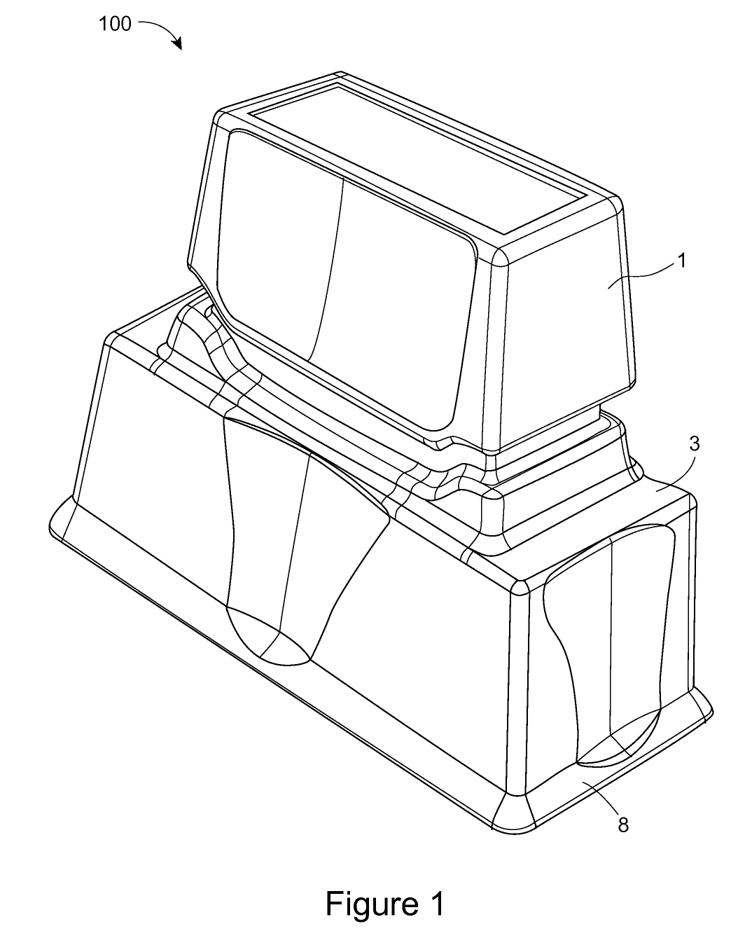

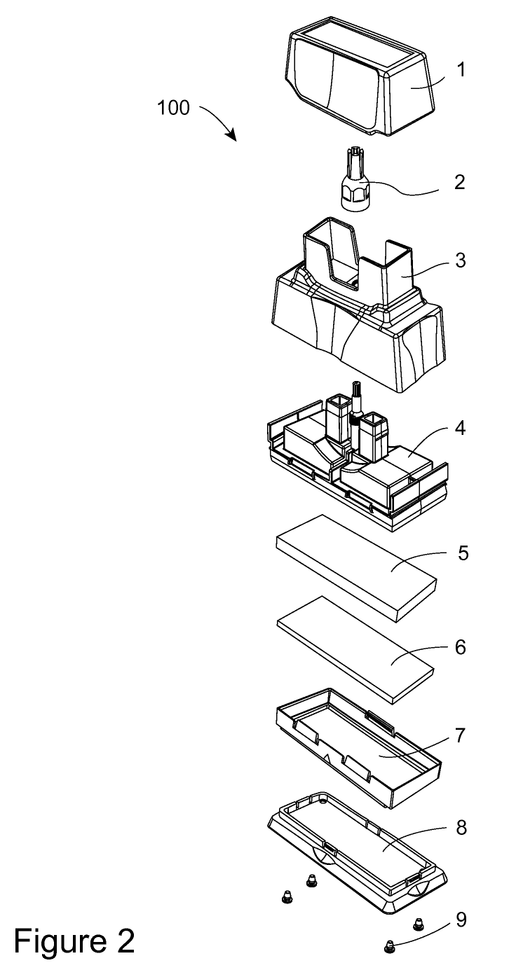

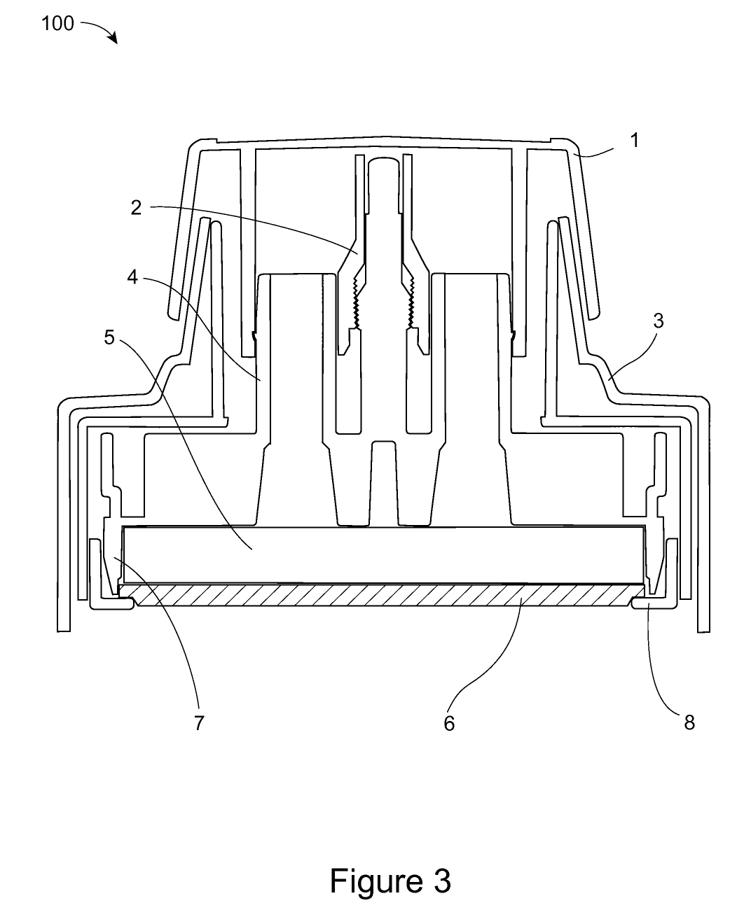

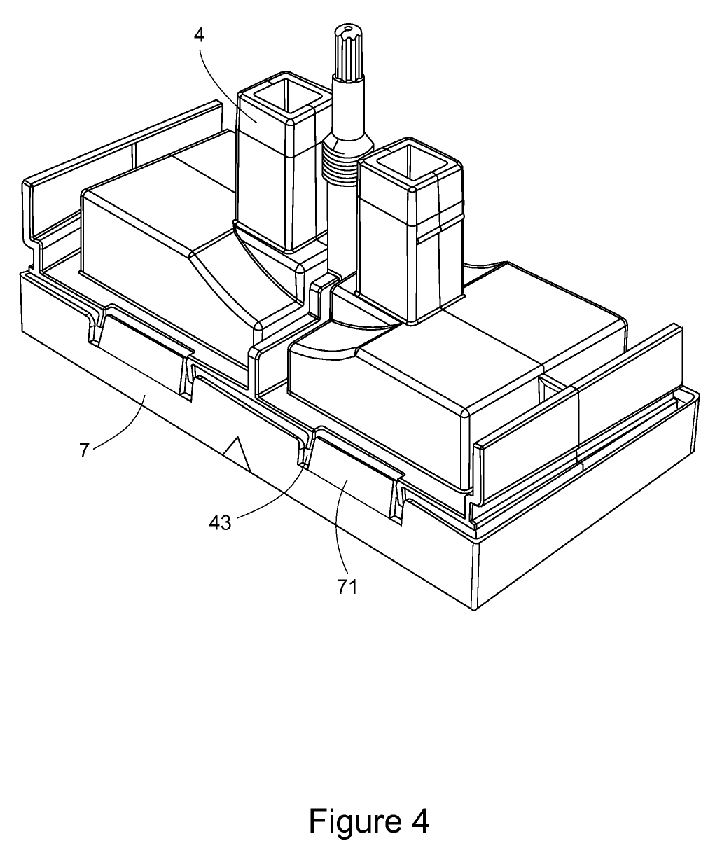

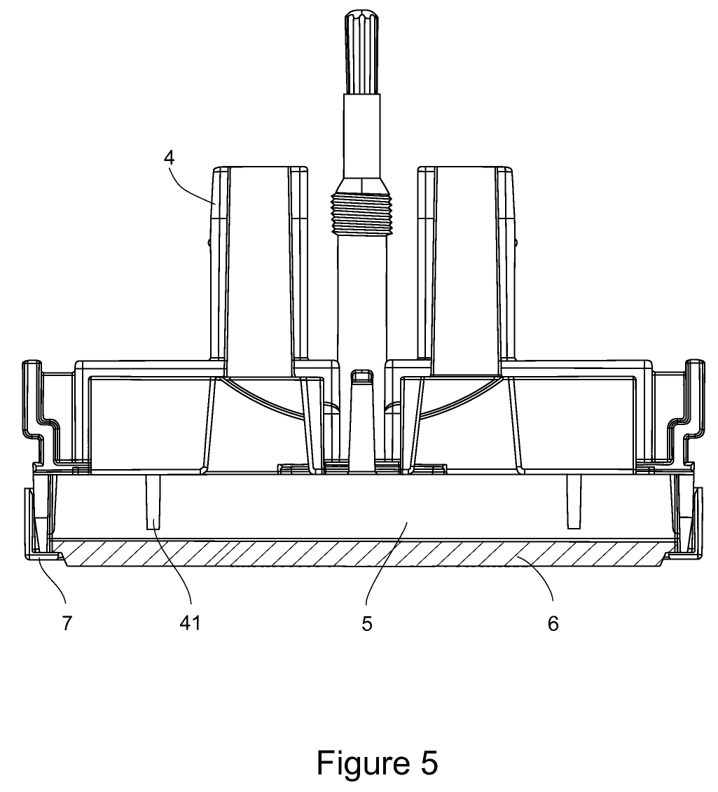

Referring to FIGS. 1-3, the embodiment of a self-inking hand stamper indicated as 100 comprises a handle 1 which snaps onto chimney 4, while ferrule 2 screws onto the threaded shaft of chimney 4, the latter passing though an opening in stamp body 3. As illustrated in FIGS. 4 and 5, components 4-7 form a sub-assembly which may be placed within stamp body 3 as described in more detail below. Dust cap 8 and rubber feet 9 (typical of four illustrated) are optional but preferred in some embodiments.

The extent of downward travel of handle 1, and thus of chimney 4, relative to stamp body 3 is limited by the extent to which ferrule 2 may travel before contacting stamp body 3. A spring, not illustrated, lies between ferrule 2 and the threaded shaft of chimney 4 and is compressed by the downward travel, thus providing sufficient spring force to return handle 1 to its initial position when it is released.

Provided that sufficient travel is permitted, once dust cover 8 is removed and stamp body 3 is placed flat onto a workpiece or surface (not shown), depressing handle 1 will urge the bottom of chimney 4 against the workpiece. It is possible, but not required, for dust cover 8 to serve as a stand or tray for the hand-held stamp be being designed so that it may be flipped over and the hand-held stamp placed within it.

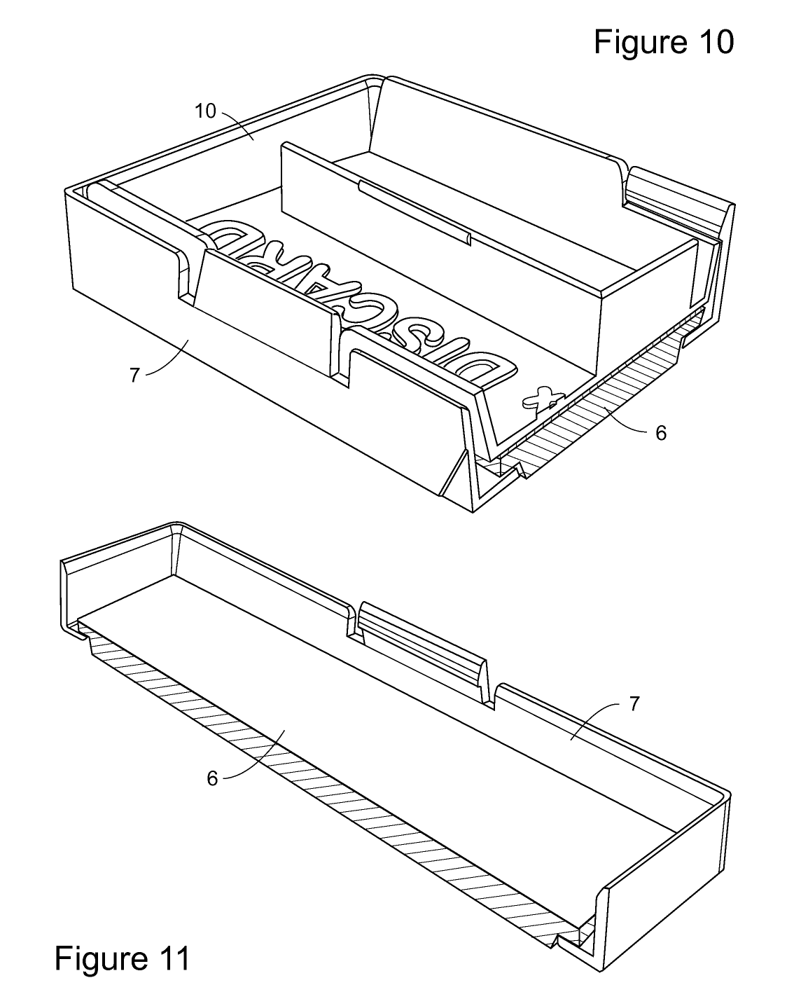

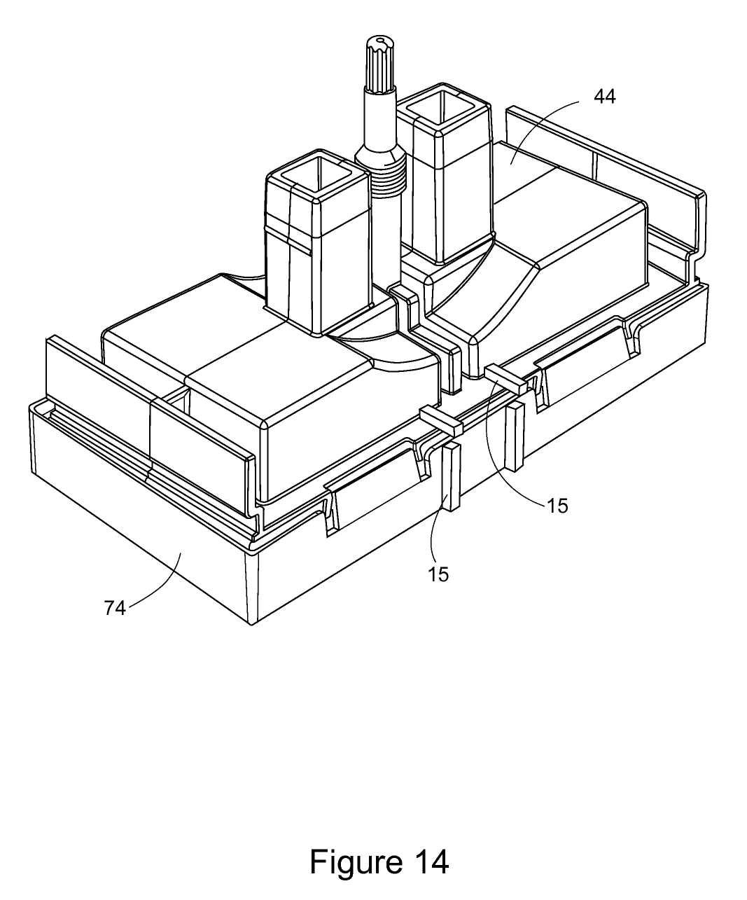

Flash foam 6 is held in place at the bottom of chimney 4 by retainer 7, which clips onto chimney 4 (see also FIGS. 4 and 5) and has an open area that exposes the bottom face of flash foam 6 to the workpiece (see also FIGS. 8, 10 and 11). Ink oozes from ink cartridge 5 onto the upper, non-printing side of flash foam 6 and then downward through the material of flash foam 6 and onto the work piece according to whatever printing pattern has been “flashed” or created on the bottom side of flash foam 6, according to principles known in the art.

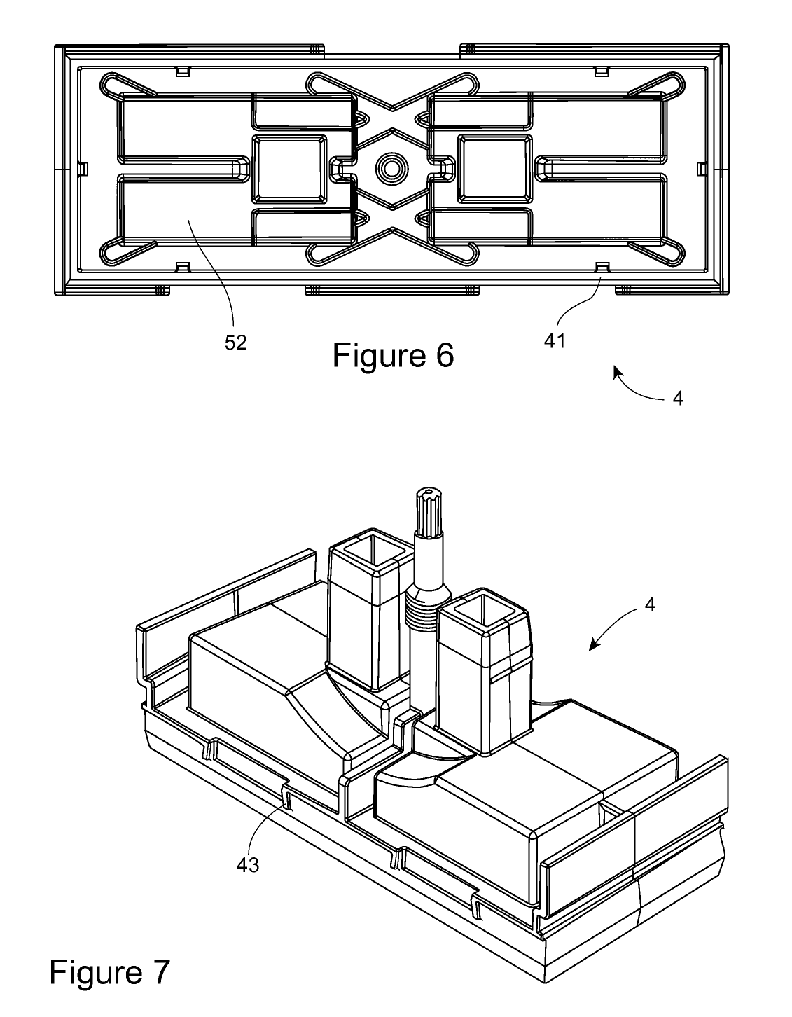

Ink cartridge 5 is supplied in a pre-inked condition, preferably pre-installed within chimney 4. As shown in FIGS. 5 and 6, various internal ribs 41 within the lower portion of chimney 4 help hold ink cartridge 5 in place. The number, location, and shape of internal ribs 41 are not critical to the scope of this embodiment. It is preferred that ink cartridge 5 be on the order of 7 mm in thickness, but this is not critical. A removable, disposable thin film (not shown) is added to the lowermost edges of chimney 4 to prevent the pre-saturated ink cartridge 5 from leaking out from the enclosed area at the lower end of chimney 4. To this end, it is desirable (but not required) that the sides of chimney 4 be on the order of 0.030 inches in thickness. Ink cartridge 5 may be re-supplied with ink by removing handle 1 and dispensing ink into either of the open columns of chimney 4. As best illustrated in FIG. 6, various clearances and other features 42 are provided to ensure that ink flows evenly over the top face of ink cartridge 5.

FIGS. 8-11 illustrate separate sub-assemblies that allow retailers at the point of sale or other field personnel to perform the flashing operation. A pre-assembled integrated combination of retainer 7 and flash foam 6 may be provided; in the preferred embodiment illustrated, clip 10 holds flash foam 6 clipped in place within retainer 7. The major portion of the lower face of flash foam 6 is exposed by the open portion of retainer 7. This sub-assembly may then be exposed to suitable radiation (e.g., Xenon flash lamp) to create the stamp pattern onto the lower face of flash foam 6, in accordance with known principles.

Then the flashed sub-assembly is clipped to chimney 4 (after removing the film mentioned above), which is provided with pre-inked ink cartridge 5 already in place within the lower portion of chimney 4 (see FIGS. 5 and 6). This procedure properly urges ink cartridge 5 against the upper or back (non-flashed) face of flash foam 6 so that the ink may ooze as described above.

The remainder of stamp 100 is then assembled in the field according to the procedure described above (accompanying FIGS. 1-5.) Use of a pre-inked and pre-assembled ink cartridge 5 in combination with chimney 4 permits that sub-assembly to be stocked in a field location well in advance of when the actual stamp is flashed and assembled at the point of sale.

Another advantage of the use of a separate sub-assembly for the flashing operation is that sub-assemblies of various types and sizes (thicknesses) may all be provided with a single universal connection between such sub-assemblies and the chimney 4. This simplifies the tasks required of field personnel, and may even permit the manufacture of stamps at the point of sale by personnel who have received little or no training in the assembly of stamper 100.

FIG. 8 also illustrates that an asymmetric configuration (i.e., a different number and/or shape) of clips 71 may be provided on each side of retainer 7 to ensure that retainer 7 is removably attached to chimney 4 in the proper orientation, thus preventing so-called “reverse assembly” in the field or at the point of sale. This prevents the stamp 100 from creating an image on the workpiece that is inverted from what the user of stamp 100 expects. (A conventional window may be provided on the top of handle 1 for a specimen of the stamped image to be placed in the proper orientation.)

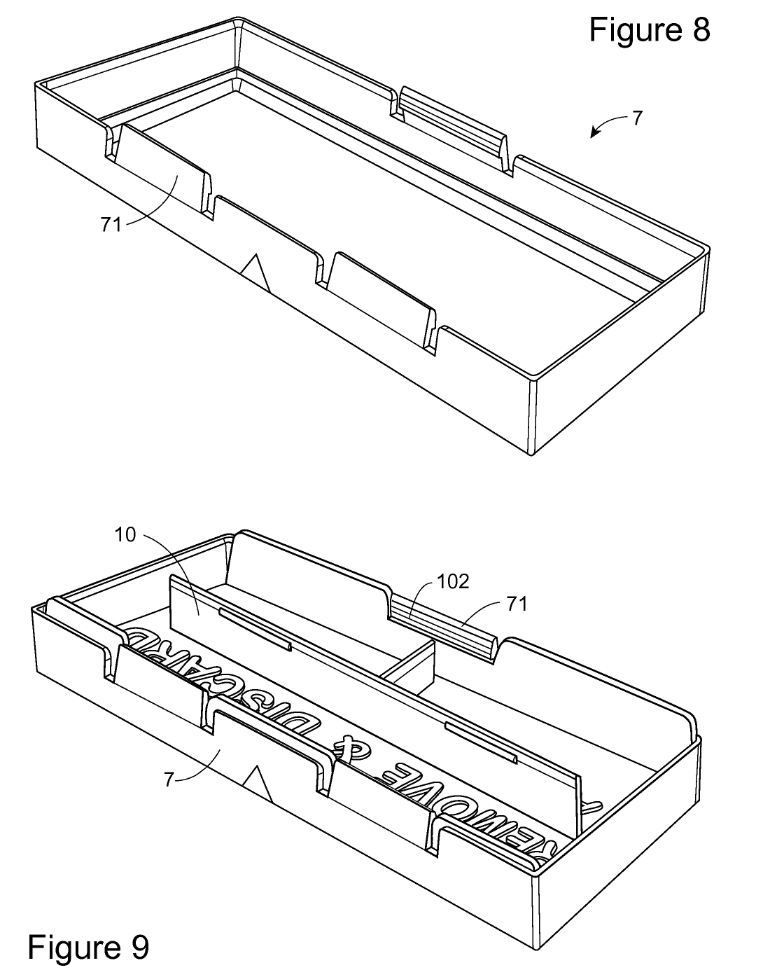

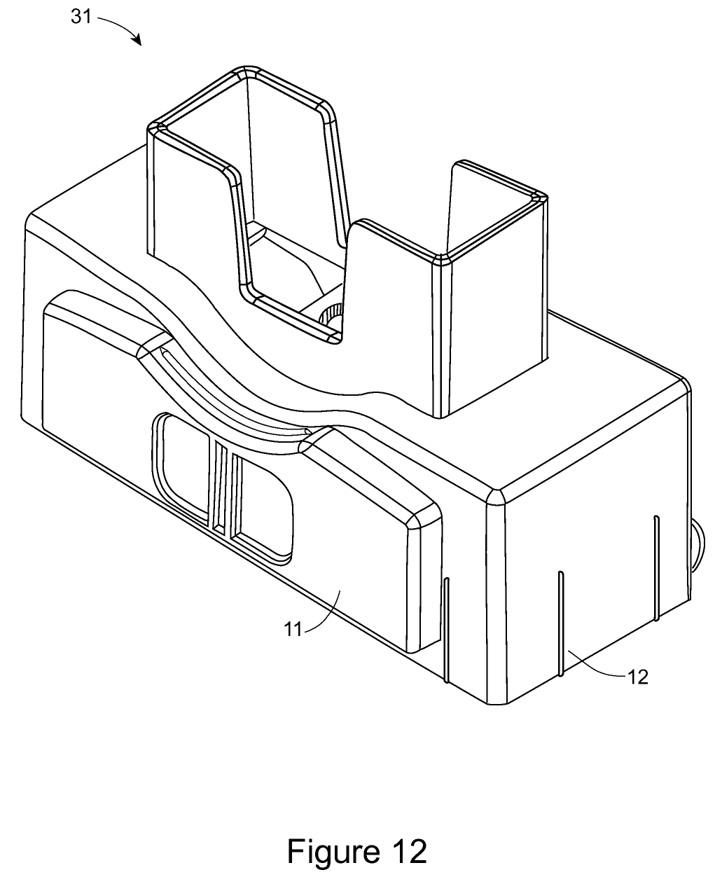

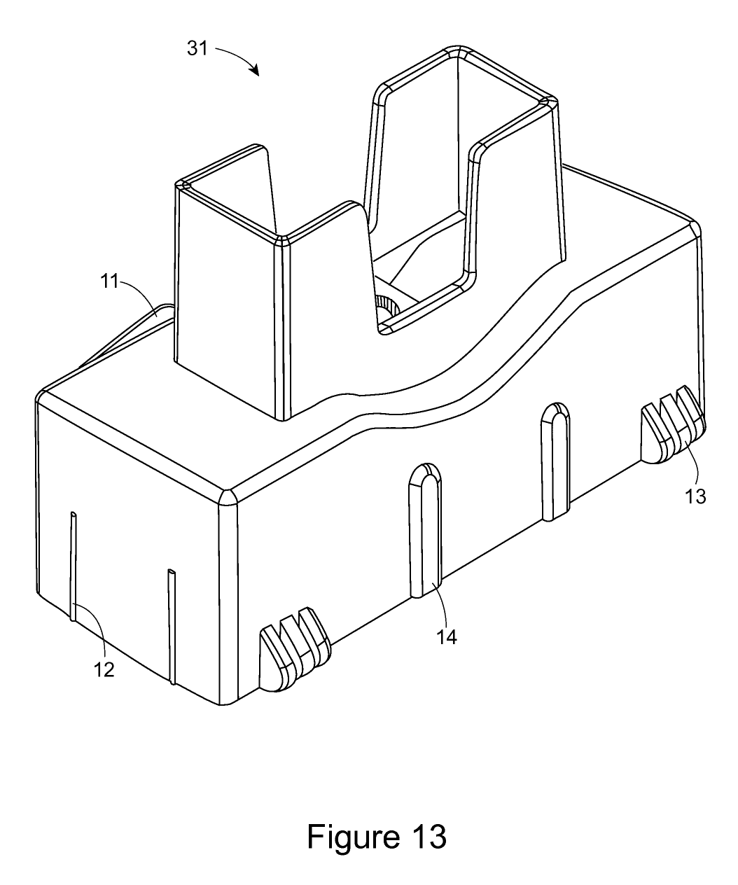

To aid in this process, various angled guides 43 are preferably included with chimney 4 (see FIGS. 4 and 7). As illustrated in FIGS. 9 and 10, these same clips 71 are also used to attach retainer 7 to mating features 101 of clip 10, thus holding flash foam 6 in position for flashing, as described above. It is also preferred to provide various chamfers and other similar features to aid construction and/or assembly.

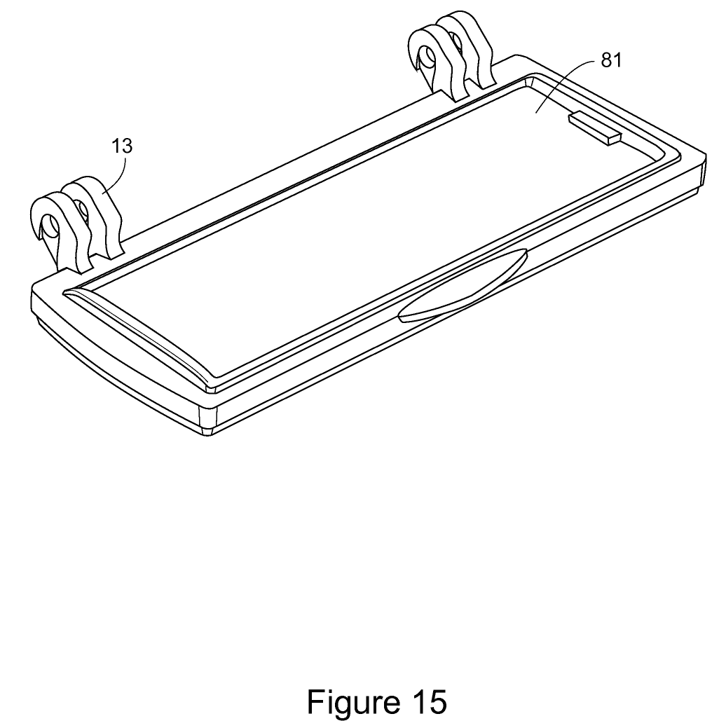

FIGS. 12 and 13 illustrate an alternative stamp body 31 which is adapted for several options that may be provided alone or in combination with each other. One option is dispenser 11, as disclosed in US Published Patent Application US2005/184080, which is incorporated by reference.

Another option is one or more positioning guides 12, which indicate the extent of the flashed image to the user of the stamp. As illustrated, the preferred but not required) positioning guides are small vertical outward fiducial lines on the outer surface of stamp body 3. In other embodiments, the positioning guides could be inwardly extending or any other type of reference marks (such as an inverted arrow or other pointed symbol, for example). They are preferably molded into stamp body 3 but they can be produced by printing, providing a sticker, or other known techniques.

A third option is hinge knuckles 13 on the outer rear face, which mate with corresponding features on hinged flip-out lid 81 (see FIG. 15). This combination may be provided in lieu of the removable (and potentially misplaced) dust cap 8 and rubber feet 9 described above, to prevent inadvertent drying out of the ink.

A fourth option is one or more alignment features 14 in stamp body 31 which are designed to mate with corresponding features 15 on a common side of either or (preferably) both of appropriately modified chimney 44 and retainer 74 (see FIG. 14), and therefore allow the assembly of the hand-held stamp in only one manner, again preventing the “reverse assembly” problem described above. This independently ensures that the flashed image is oriented as desired, i.e., not upside down compared to the specimen in the top of the handle and/or the typical position of the dispenser 11—facing the user—if the latter is present.

### Component Details

Many of the specific details of the components described in this application are dictated to large degree by the design and engineering of the preferred embodiment illustrated. However, such details are not necessarily required in the broadest embodiment enabled by this application. Similarly, alternative constructions that achieve the same functions as the components and features described n this application are within the scope of the broadest embodiment, unless specifically excluded by the claims.

### Manufacturing Details

The design of the embodiments described above also provide for advantageous methods of manufacturing a stamper at the point of sale, as described below. However, such methods are not necessarily provided by only the embodiments described above.

### Advantages

The embodiments described above enable the manufacture of flashed stamps in approximately fifteen minutes in a field or point of sale setting, as opposed to a system in which they must be ordered from a central manufacturing setting and delivered in one or two days, if not longer.

The use of separate sub-assemblies for the flashed components and the ink cartridge provides distinct advantages over the approach disclosed in U.S. Pat. No. 7,096,785, in which the ink cartridge is contained within the “die box” that also contains the porous foam material that is flashed during image creation. It is also not necessary to employ a separate material between the ink reservoir and the flash foam, for the purpose of increasing the flow of ink from the ink reservoir to the flash foam.

1. A self-inking hand-held stamp, comprising a stamp body; a first sub-assembly having a pre-inked ink cartridge; and a second, separate sub-assembly that may be flashed with a desired stamp image prior to combination of the second sub-assembly and the first subassembly for insertion of the combination into the stamp body.

2. The hand-held stamp of claim 1, further comprising a retainer which combines the second sub-assembly and the first subassembly.

3. The hand-held stamp of claim 2, in which the retainer comprises a set or clips, and the second sub-assembly is clipped to the first sub-assembly by an asymmetrical configuration of the clips.

4. The hand-held stamp of claim 1, further comprising a chimney which positions the first sub-assembly to provide ink to a non-flashed back face of the second sub-assembly when the chimney is urged toward a workpiece.

5. The hand-held stamp of claim 1, in which the second sub-assembly comprises a retainer and a flash foam within the retainer, in which the retainer has an open portion that exposes a major portion of a lower face of the flash foam.

6. The hand-held stamp of claim 1, in which the stamp body further comprises at least one positioning guide to indicate the extent of the flashed stamp image to a user of the stamp.

7. The hand-held stamp of claim 1, further comprising a base hinged to the stamp body.

8. The hand-held stamp of claim 1, in which the stamp body further comprises at least one alignment feature which mates with a corresponding feature on at least one of the first and second sub-assemblies to allow assembly of the hand-held stamp in only one manner to ensure that the flashed image is oriented as desired.

9. A method of providing a self-inking hand-held stamp, comprising providing a stamp body, a first sub-assembly having an ink cartridge supplied in a pre-inked condition, and a second, separate sub-assembly to be flashed with a desired stamp image; in which the first and second sub-assemblies are combined after flashing and inserted into the stamp body.

10. The method of claim 2, in which the stamp body further comprises a chimney that positions the first sub-assembly to provide ink to a non-flashed back face of the second sub-assembly when the chimney is urged toward a workpiece.

11. The method of claim 2, additionally providing the second sub-assembly with a retainer having an open portion, and a flash foam within the retainer such that the open portion exposes a major portion of a lower face of the flash foam.
